(19) United States
(12) Patent Application Publication
(10) Pub. No.: US 2004/0002000 A1
(43) Pub. Date: Jan. 1, 2004

(54) Secondary battery

(75) Inventors: Etsuo Oogami, Kanagawa (JP); Norihiko Hirata, Kanagawa (JP)

Correspondence Address: McDERMOTT, WILL & EMERY, 600 13th Street, N.W., Washington, DC, 20005-3096, US

(73) Assignee: Nissan Motor Co., Ltd.

(21) Appl. No.: 10/465,646

(22) Filed: Jun. 20, 2003

(30) Foreign Application Priority Data
Jun. 26, 2002 (JP) 2002-186114

(51) Int. Cl. H01M 2/02; H01M 2/08; H01M 2/30

(52) U.S. Cl. 429/162; 429/181; 429/180

(57) ABSTRACT

A secondary battery comprises a case having first and second flat end portions. A generator unit is installed in the case. The generator unit includes a plurality of positive and negative electrode plates which are alternatively put on one another placing therebetween separator plates. Positive and negative flat terminals are respectively held by the first and second end portions of the case. Each of the flat terminals includes an inside part exposed to an interior of the case and connected to corresponding ones of the positive and negative electrode plates, a middle part actually held by corresponding one of the first and second flat end portions of the case and an outside part exposed to the outside of the case. A reinforcing structure is associated with the first and second flat end portions of the case to assure and reinforce the holding of the middle part of each flat terminal by corresponding one of the first and second flat end portions of the case.

### BACKGROUND OF THE INVENTION

1. Field of the Invention

The present invention relates in general to batteries and more particularly to secondary batteries of a thin type which generally comprises a case, a generator unit installed in the case and positive and negative flat terminals connected to the generator unit.

2. Description of the Related Art

To provide a high voltage and high capacity battery, it has been commonly employed to stack a plurality of thin type batteries while connecting them in series. One of the thin type batteries for that use is shown in Laid-open Japanese Patent Application (Tokkaihei) 9-259859. In this battery, positive and negative terminals are constructed of aluminum or copper foils. However, due to delicate structure of the terminals of such foils, a skilled and thus costly technique is needed for safely connecting the terminals of the batteries in order not to damage the terminals.

### SUMMARY OF THE INVENTION

It is therefore an object of the present invention to provide a secondary battery of which positive and negative flat terminals have a high durability against a stress applied thereto.

According to a first aspect of the present invention, there is provided a secondary battery which comprises a case having first and second flat end portions; a generator unit installed in the case, the generator unit including a plurality of positive and negative electrode plates which are alternatively put on one another placing therebetween separator plates; positive and negative flat terminals respectively held by the first and second end portions of the case, each of the flat terminals including an inside part exposed to an interior of the case and connected to corresponding ones of the positive and negative electrode plates, a middle part actually held by corresponding one of the first and second flat end portions of the case and an outside part exposed to the outside of the case; and a reinforcing structure associated with the first and second flat end portions of the case to assure and reinforce the holding of the middle part of each flat terminal by corresponding one of the first and second flat end portions of the case.

According to a second aspect of the present invention, there is provided a secondary battery which comprises a case having first and second flat end portions; a generator unit installed in the case, the generator unit including a plurality of positive and negative electrode plates which are alternatively put on one another placing therebetween separator plates; positive and negative flat terminals respectively held by the first and second end portions of the case, each of the flat terminals including an inside part exposed to an interior of the case and connected to corresponding ones of the positive and negative electrode plates, a middle part actually held by corresponding one of the first and second flat end portions of the case and an outside part exposed to the outside of the case; a first projected portion possessed by the first end portion of the case, the first projected portion being put on both surfaces of the positive flat terminal and extending toward a leading end of the positive flat terminal; and a second projected portion possessed by the second end portion of the case, the second projected portion being put on both surfaces of the negative flat terminal and extending toward a leading end of the negative flat terminal.

According to a third aspect of the present invention, there is provided a secondary battery as defined in the above-mentioned second aspect in which the first projected portion substantially entirely covers the middle and outside parts of the positive flat terminal and the second projected portion substantially entirely covers the middle and outside parts of the negative flat terminal, and in which the first projected portion is formed with at least one opening through which a portion of the positive flat terminal is exposed to the outside of the case, and the second projected portion is formed with at least one opening through which a portion of the negative flat terminal is exposed to the outside of the case.

According to a fourth aspect of the present invention, there is provided a secondary battery which comprises a case having first and second flat end portions; a generator unit installed in the case, the generator unit including a plurality of positive and negative electrode plates which are alternatively put on one another placing therebetween separator plates; positive and negative flat terminals respectively held by the first and second end portions of the case, each of the flat terminals including an inside part exposed to an interior of the case and connected to corresponding ones of the positive and negative electrode plates, a middle part actually held by corresponding one of the first and second flat end portions of the case and an outside part exposed to the outside of the case; a first sealing layer of melted plastic film through which the middle part of the positive flat terminal is held by the first flat end portion of the case; and a second sealing layer of melted plastic film through which the middle part of the negative flat terminal is held by the second flat end portion of the case, wherein each of the first and second sealing layers has an outside edge that projects by a given degree from a leading edge of corresponding one of the first and second flat end portions of the case toward a leading end of the outside part of the corresponding one of the positive and negative flat terminals.

### BRIEF DESCRIPTION OF THE DRAWINGS

Other objects and advantages of the present invention will become apparent from the following description when taken in conjunction with the accompanying drawings, in which:

FIG. 1A is a plan view of a thin type secondary battery which is a first embodiment of the present invention;

FIG. 1B is a sectional view taken along the line “1B-1B” of FIG. 1A;

FIG. 2 is a partial plan view of a thin type secondary battery which is a second embodiment of the present invention;

FIG. 3 is a view similar to FIG. 2, but showing a thin type secondary battery of a third embodiment of the present invention;

FIGS. 4A, 4B and 4C are views of a thin type secondary battery which is a fourth embodiment of the present invention, in which FIG. 4A is a partial plan view of the battery of the fourth embodiment, FIG. 4B is a plan view of an essential portion of the battery of the fourth embodiment, and FIG. 4C is a sectional view taken along the line “4C-4C” of FIG. 4A; and

FIGS. 5A and 5B are views of a thin type secondary battery of a fifth embodiment of the present invention, in which FIG. 5A is a partial plan view of the battery of the fifth embodiment and FIG. 5B is a sectional view taken along the line “5B-5B” of FIG. 5A.

### DETAILED DESCRIPTION OF THE EMBODIMENTS

In the following, four embodiments 100, 200, 300 and 400 of the present invention will be described in detail with reference to the accompanying drawings. For ease of understanding, various directional terms, such as, right, left, upper, lower, rightward and the like are used in the description. However, such terms are to be understood with respect to only a drawing or drawings on which corresponding portion or part is shown.

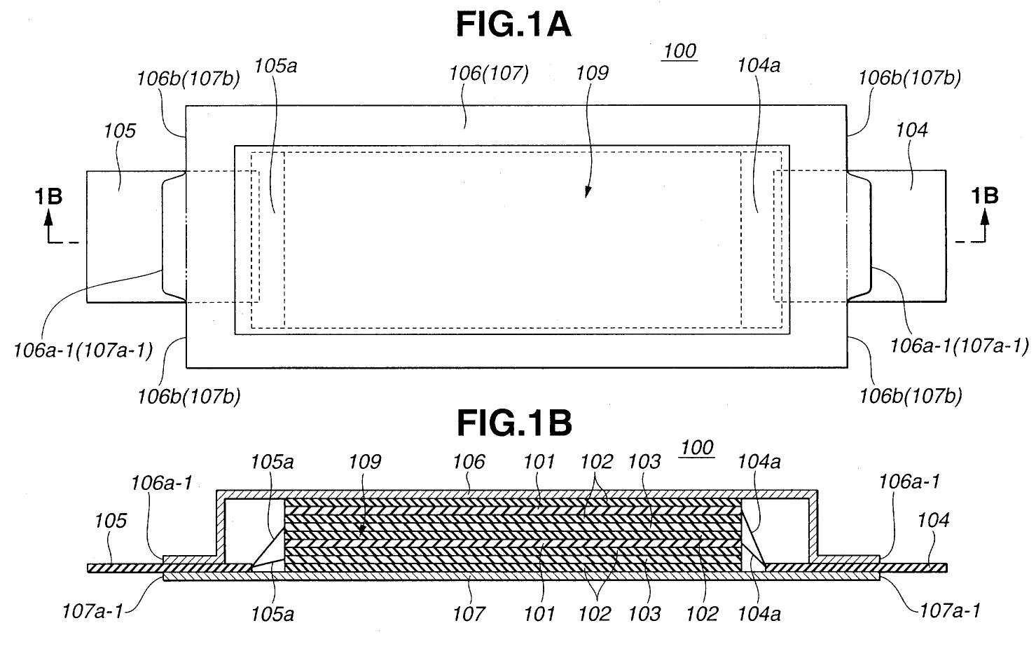

Referring to FIGS. 1A and 1B, there is shown a lithium ion secondary battery 100 of a thin type, which is a first embodiment of the present invention.

In practical use, a plurality of such batteries 100 are stacked on one another to constitute a laminated battery unit that exhibits a desired high voltage and high capacity.

As is seen from FIG. 1B, the secondary battery 100 comprises upper and lower case parts 106 and 107 which are coupled to constitute a case that has a flat space defined therein.

Within the flat space, there are laid two, viz., upper and lower positive electrode plates 101 and two, viz., upper and lower negative electrode plates 103, which are arranged in such a manner that the upper negative electrode plate 103 is sandwiched between the upper and lower positive electrode plates 101 having the lower negative electrode plate 103 placed below the lower positive electrode plate 101. Within three flat spaces defined between the upper positive and upper negative electrode plates 101 and 103, between the upper negative and lower positive electrode plates 103 and 101 and between the lower positive and lower negative electrode plates 101 and 103, there are inserted respective separator plates 102. Furthermore, on the upper positive electrode plate 101 and beneath the lower negative electrode plate 103, there are laid respective separator plates 102. Although not shown in the drawings, these plates 101, 102 and 103 are pregnant with an electrolyte and constitute a generator unit 109.

It is to be noted that these plates 101, 102 and 103 have no limitation in number. That is, for example, one positive electrode plate 101, three separator plates 102 and one negative electrode plate 103 can constitute a generator unit 109. Depending on the need for a desired voltage and capacity, the number of the plates 101, 102 and 103 may change.

For producing positive electrode plate 101, a mixture is prepared, which comprises 100 parts by weight of anode active material, such as metallic oxide or the like, 3 parts by weight of conductive material, such as carbon black or the like and 10 parts by weight of an adhesive that is, for example, water dispersion of polytetrafluoroethylene. The mixture is applied to or coated on both surfaces of a metallic foil, such as aluminum foil or the like, then dried and rolled. Thereafter, the rolled foil is cut into a piece having a desired size for the positive electrode plate 101. It is to be noted that the mixing ratio of the water dispersion of polytetrafluoroethylene is based on the weight of solid component of the polytetrafluoroethylene.

As the anode active material, a lithium double oxide, such as LiNiO₂, LiMnO₂, LiCoO₂ or the like, or a chalcogen compound (S, Se, Te) is usable.

For producing negative electrode plate 103, a mixture is prepared, which comprises 100 parts by weight of cathode active material, such as amorphous carbon, non-easily graphitizing carbon, easily graphitizing carbon or graphite and 5 parts by weight of water dispersion of powder of styrene-butadiene rubber. That is, the cathode active material is a material that can occlude and release lithium ions from the anode active material. The water dispersion of powder of styrene-butadiene rubber is a precursor of an organic burned substance produced. The mixture is dried and crushed to pieces to prepare a main material that includes carbon powder coated with a carbonized styrene-butadiene rubber. Then, a mixture of 100 parts by weight of the main material and 5 parts by weight of an acrylic resin emulsion as a binder is prepared and applied to or coated on both surfaces of a metallic foil, such as nickel or cupper foil, and then dried and rolled. Thereafter, the rolled foil is cut into a piece having a desired size for the negative electrode plate 103.

When amorphous carbon or non-easily graphitizing carbon is used for the cathode active material, the leveling characteristic of the battery at charging/discharging time becomes poor and the output voltage of the battery becomes low with increase of discharge amount. Thus, such battery is not suitable for a power source of communication instruments and business machines. However, such battery is suitable for the power source of an electric vehicle because it does not exhibit a sudden power drop.

The separator plate 102 functions to avoid direct contact between positive and negative electrode plates 101 and 103. The separator plate 102 may have a function to hold a suitable electrolyte therein. The separator plate 102 is a porous membrane made of, for example, a polyolefine, such as polyethylene (PE), polypropylene (PP) or the like, having a thickness of about 25 μm to 50 μm. If separator plate 102 is subjected to an over-current, the pores of the plate 102 are closed due to a heat generated by the current and thus block the current. If desired, the separate plate 102 may have a three-layered structure including a polypropylene layer sandwiched between polyethylene layers or a layered structure including a porous polyolefine layer and an organic non-woven fabric that is put on the layer. By making separate plate 102 as having a layered structure, various additional functions are obtained, which are, for example, suppression of over-current, holding of electrolyte and increase in rigidity. In place of the separate plate 102, gel electrolyte or true polymer electrolyte may be used.

As has been mentioned hereinabove, in the thin type secondary battery 100 shown in FIGS. 1A and 1B, two positive electrode plates 101 and two negative electrode plates 103 are put on one another alternatively, and between neighboring positive and negative electrode plates 101 and 103, there is sandwiched a separator plate 102. Furthermore, on the upper positive electrode plate 101 and beneath the lower negative electrode plate 103, there are put separator plates 102 respectively. The upper and lower positive electrode plates 101 are connected to a positive flat terminal 104 of metal foil through positive side collectors 104a which are integral with the positive terminal 104. While, the upper and lower negative electrode plates 103 are connected to a negative flat terminal 105 of metal foil through negative side collectors 105a which are integral with the negative terminal 105. The positive and negative flat terminals 104 and 105 are made of a metal foil that exhibits a satisfied electrochemical durability. Preferably, positive flat terminal 104 is made of aluminum foil or aluminum-alloy foil and negative flat terminal 105 is made of nickel foil, copper foil or stainless foil. If desired, positive and negative side collectors 104a and 105a may be made of metals that are separate from positive and negative flat terminals 104 and 105.

The generator unit 109 having the above-mentioned structure is sealably installed in the closed case constructed by upper and lower case parts 106 and 107. These upper and lower case parts 106 and 107 are each made of a plastic film such as polyethylene, polypropylene or the like, or a laminate plate that includes a metal foil whose both surfaces are covered with such plastic film. Preferably, the plastic film constituting or covering an inner surface of each case part 106 or 107 is made of polyethylene, polypropylene or ionomer resin that exhibits a satisfied chemical resistance against the electrolyte as well as a satisfied sealing ability under heated condition. Furthermore, the plastic film constituting or covering an outer surface of each case 106 or 107 is made of polyamide resin or polyester resin that exhibits a satisfied electric insulating property. Furthermore, if desired, between the case part 106 or 107 and the inner surface covering film, a metal foil, such as aluminum foil, stainless foil or the like may be disposed for increasing the mechanical strength of the case part.

In order to assemble the secondary battery 100, the generator unit 109, positive side collectors 104a, part of positive terminal 104, negative side collectors 105a and part of negative terminal 105 are put between upper and lower case parts 106 and 107. Then, into the enclosed space defined between the case parts 106 and 107, there is poured a liquid electrolyte which includes a lithium salt, such as lithium perchlorate or boron-lithium fluoride, dissolved in an organic solvent. Then, by using a heat sealing technique, the two case parts 106 and 107 are securely connected at peripheral edges thereof while sealing the enclosed space defined therebetween.

As the organic solvent, an ester-system solvent, such as propylene carbonate (PC), ethylene carbonate (EC), di-methyl carbonate (DMC) or the like is usable. However, other solvents may be used in the present invention, which are, for example, a mixture of the ester-system solvent with an ether-system solvent, such as, γ-butyrolactone (γ-BL), di-ethoxyethan (DEF) or the like, and the like.

As is seen in FIG. 1B, positive flat terminal 104 is put between respective right ends of upper and lower case parts 106 and 107. For achieving a sealing between each of the respective right ends of case parts 106 and 107 and positive terminal 104, a sealing layer made of polyethylene film, polypropylene film or the like, may be disposed therebetween through a heat sealing method.

Similar to positive flat terminal 104, negative flat terminal 105 is also put between respective left ends of upper and lower case parts 106 and 107. Thus, such sealing layer may be applied between them.

In view of the heat-sealing facility, it is preferable that a seal film for that sealing layer is selected from the same plastic group as that of the plastic film that forms the inner surfaces of case parts 106 and 107.

As is seen from FIGS. 1A and 1B, respective right ends of upper and lower case parts 106 and 107 comprise each a base part 106b or 107b and a trapezoidal part 106a-1 or 107a-1 that projects rightward from base part 106b or 107b. Similar to this, respective left ends of upper and lower case parts 106 and 107 comprise each a base part 106b or 107b and a trapezoidal part 106a-1 or 107a-1 that projects leftward from base part 106b or 107b. That is, as is seen from FIG. 1A, the trapezoidal right and left parts 106a-1 or 107a-1 are entirely put on positive flat terminal 104 and negative flat terminal 105 respectively.

Because of provision of trapezoidal part 106a-1 or 107a-1 which projects from base part 106b or 107b, any external force applied to positive or negative flat terminal 104 or 105 is appropriately absorbed or damped by the part 106a-1 or 107a-1. In fact, a stress caused by such external force is collected along the periphery of the trapezoidal part 106a-1 or 107a-1. However, due to the non-linear shape of the periphery of the part 106a-1 or 107a-1, the stress is appropriately dispersed.

Accordingly, even if a plurality of secondary batteries 100 having the above-mentioned structure are stacked to constitute a laminated battery unit with usage of a bus-bar, external forces inevitably applied to the positive and negative terminals 104 and 105 are appropriately absorbed by the trapezoidal parts 106a-1 and 107a-1, and thus, undesired breakage of base parts-106b and 107b and their associated portions, which would often happen in a conventional battery unit, is assuredly avoided.

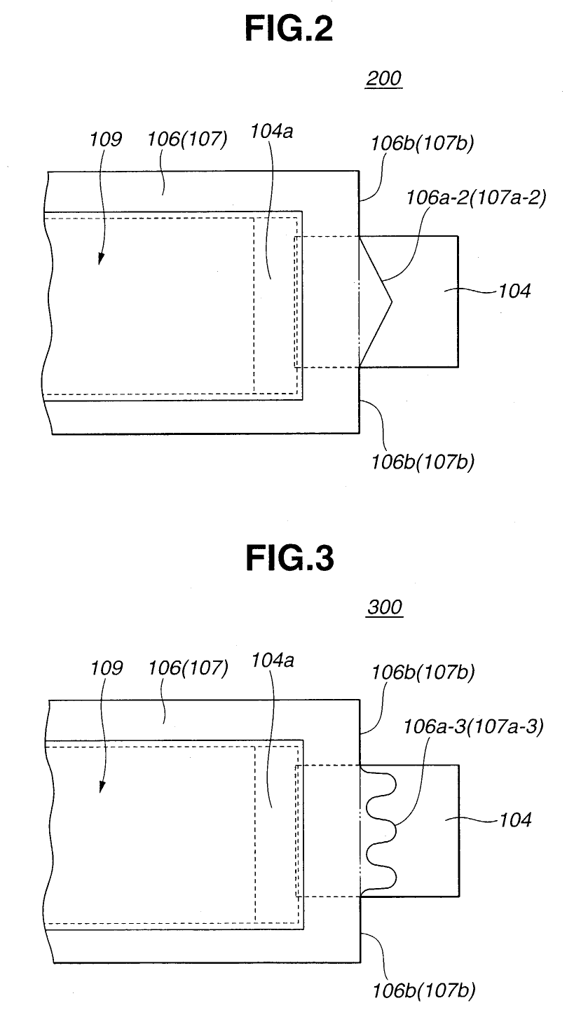

Referring to FIG. 2, there is partially shown a lithium ion secondary battery 200 of thin type, which is a second embodiment of the present invention.

As shown, in this second embodiment, the respective right or left ends of upper and lower case parts 106 and 107 comprise each a base part 106b or 107b and a triangular part 106a-2 or 107a-2 that projects rightward or leftward from base part 106b or 107b. Because of the same reasons as mentioned in the first embodiment 100, undesired breakage of base parts 106b and 107b is assuredly avoided.

Referring to FIG. 3, there is partially shown a lithium ion secondary battery 300 of thin type, which is a third embodiment of the present invention.

As shown, in this third embodiment, the respective right or left ends of upper and lower case parts 106 and 107 comprise each a base part 106b or 107b and a wave-shaped part 106a-3 or 107a-3 that projects rightward or leftward from base part 106b or 107b. Because of the same reasons as mentioned hereinabove, undesired breakage of base parts 106b and 107b and their associated portions is assuredly avoided.

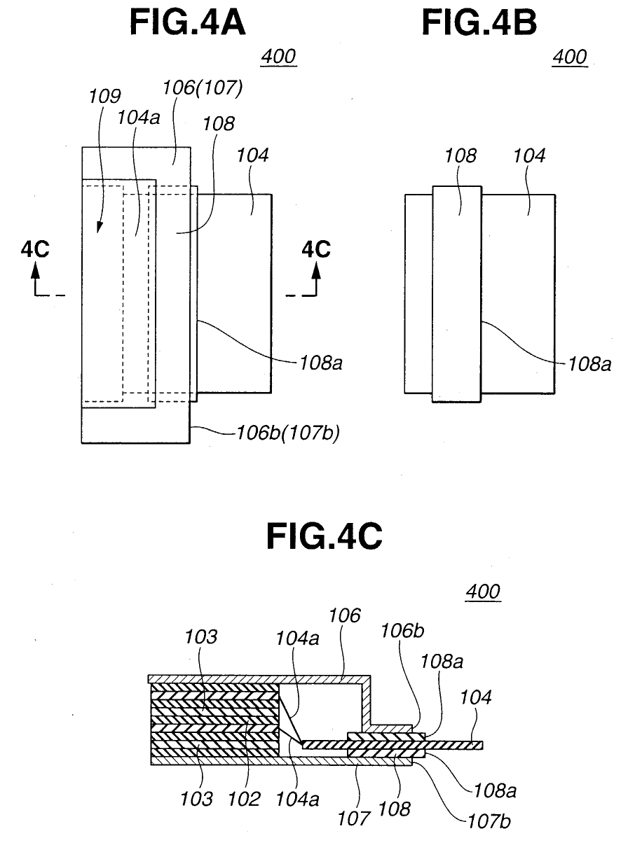

Referring to FIGS. 4A, 4B and 4C, there is partially shown a lithium ion secondary battery 400 of thin type, which is a fourth embodiment of the present invention.

In this fourth embodiment, a sealing layer 108 is provided between each of the ends 106b and 107b of upper and lower case parts 106 and 107 and positive or negative terminal 104 or 105.

As may be understood from FIG. 4C, for making sealing layer 108, a plastic film made of polyethylene, polypropylene, polyamide, ionomer or the like is put in such clearances and a certain heat is applied to the film to melt the same. Due to provision of the sealing layer 108, the interior of the case (106+107) is hermetically isolated from the outside.

As is seen from the drawings, outside edges 108a of the sealing layer 108 project rightward from base parts 106b and 107b of the upper and lower case parts 106 and 107. It is to be noted that the projected edges 108a of sealing layer 108 serve as the above-mentioned projected parts 106a-1, 107a-1, 106a-2, 107a-2, 106a-3 and 107a-3. Accordingly, undesired breakage of base parts 106b and 107b of upper and lower case parts 106 and 107 and their associated portions is assuredly avoided.

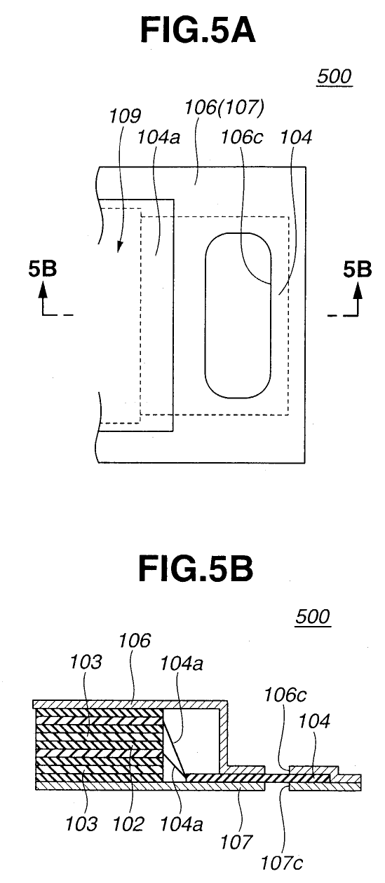

Referring to FIGS. 5A and 5B, there is partially shown a lithium ion secondary battery 500 of thin type, which is a fifth embodiment of the present invention.

In this fifth embodiment 500, positive and negative flat terminals 104 and 105 are substantially entirely covered by the right and left ends of upper and lower case parts 106 and 107. For connecting the flat terminals 104 and 105 to bus bars (not shown), the right and left ends are provided with openings 106c and 107c through which parts of the flat terminals 104 and 105 are exposed.

For producing the secondary battery 500 of this fifth embodiment, the following production steps may be employed.

First, upper and lower case parts 106 and 107 having enlarged end portions are prepared. As is seen from FIG. 5A, each of the enlarged end portions is punched to have a generally rectangular opening 106c or 107c. Then, as is seen from FIG. 5B, each of the positive and negative flat terminals 104 and 105 is put between the enlarged end portions, and by employing a heat sealing method, a certain heat is applied to the end portions to melt the same.

Because of the enlarged end portions by which the positive and negative flat terminals 104 and 105 are substantially covered, any external force applied to the flat terminals 104 and 105 is appropriately absorbed or damped by the enlarged end portions. Since flat terminals 104 and 105 are covered by the end portions of upper and lower case parts 106 and 107, durability of the flat terminals 104 and 105 is increased. Furthermore, for the same reason, undesired short circuit of the terminals 104 and 105 with surrounding electric parts is avoided. Furthermore, since sharp corners of each terminal 104 or 105 are covered by the end portions of the case parts 106 and 107, neighboring parts are prevented from being scratched by the sharp corners.

Although the above description is directed to the secondary battery of thin type, the invention is widely applicable to batteries of other type.

The entire contents of Japanese Patent Application 2002-186114 (filed Jun. 26, 2002) are incorporated herein by reference.

Although the invention has been described above with reference to the embodiments of the invention, the invention is not limited to such embodiments as described above. Various modifications and variations of such embodiments may be carried out by those skilled in the art, in light of the above description.

What is claimed is:

1. A secondary battery comprising:
a case having first and second flat end portions;
a generator unit installed in the case, the generator unit including a plurality of positive and negative electrode plates which are alternatively put on one another placing therebetween separator plates;
positive and negative flat terminals respectively held by the first and second end portions of the case, each of the flat terminals including an inside part exposed to an interior of the case and connected to corresponding ones of the positive and negative electrode plates, a middle part actually held by corresponding one of the first and second flat end portions of the case and an outside part exposed to the outside of the case; and
a reinforcing structure associated with the first and second flat end portions of the case to assure and reinforce the holding of the middle part of each flat terminal by corresponding one of the first and second flat end portions of the case.

2. A secondary battery as claimed in claim 1, in which the reinforcing structure comprises:
upper and lower given portions of corresponding one of the first and second flat end portions of the case, each of the upper and lower given portions projecting from a base portion of the flat end portion of the case toward a leading end of the outside part of the corresponding one of the positive and negative flat terminals.

3. A secondary battery as claimed in claim 2, in which each of the upper and lower given portions is trapezoidal in shape.

4. A secondary battery as claimed in claim 2, in which each of the upper and lower given portions is triangular in shape.

5. A secondary battery as claimed in claim 2, in which each of the upper and lower given portions has a waved-shaped leading end.

6. A secondary battery as claimed in claim 1, in which the reinforcing structure comprises:
a first sealing layer through which the middle part of the positive flat terminal is held by the first flat end portion of the case; and
a second sealing layer through which the middle part of the negative flat terminal is held by the second flat end portion of the case,
wherein each of the first and second sealing layers has an outside edge that projects by a given degree from a leading edge of corresponding one of the first and second flat end portions of the case toward a leading end of the outside part of the corresponding one of the positive and negative flat terminals.

7. A secondary battery as claimed in claim 6, in which each of the first and second sealing layers is constructed of a melted plastic film.

8. A secondary battery as claimed in claim 1, in which the reinforcing structure comprises:
a first part of the first flat end of the case, which substantially entirely covers the middle and outside parts of the positive flat terminal;
a second part of the second flat end of the case, which substantially entirely covers the middle and outside parts of the negative flat terminal;
a first opening provided in the first part to expose a part of the positive flat terminal to the outside of the case; and
a second opening provided in the second part to expose a part of the negative flat terminal to the outside of the case.

9. A secondary battery as claimed in claim 8, in which each of the first and second flat end portions of the case is formed with two openings through which upper and lower surfaces of corresponding one of the positive and negative flat terminals are exposed to the outside of the case.

10. A secondary battery as claimed in claim 1, in which each of the positive electrode plates of the generator unit contains at least one of LiNiO₂, LiMnO₂, LiCoO₂ and chalcogen compounds of S, Se and Te.

11. A secondary battery as claimed in claim 10, in which each of the negative electrode plates of the generator unit contains amorphous carbon.

12. A secondary battery as claimed in claim 11, in which each separator plate of the generator unit has a thickness of about 25 μm to 50 μm.

13. A secondary battery comprising:
a case having first and second flat end portions;
a generator unit installed in the case, the generator unit including a plurality of positive and negative electrode plates which are alternatively put on one another placing therebetween separator plates;
positive and negative flat terminals respectively held by the first and second end portions of the case, each of the flat terminals including an inside part exposed to an interior of the case and connected to corresponding ones of the positive and negative electrode plates, a middle part actually held by corresponding one of the first and second flat end portions of the case and an outside part exposed to the outside of the case;
a first projected portion possessed by the first end portion of the case, the first projected portion being put on both surfaces of the positive flat terminal and extending toward a leading end of the positive flat terminal; and
a second projected portion possessed by the second end portion of the case, the second projected portion being put on both surfaces of the negative flat terminal and extending toward a leading end of the negative flat terminal.

14. A secondary battery as claimed in claim 13, in which the first projected portion substantially entirely covers the middle and outside parts of the positive flat terminal and the second projected portion substantially entirely covers the middle and outside parts of the negative flat terminal.

15. A secondary battery as claimed in claim 14, in which the first projected portion is formed with at least one opening through which a portion of the positive flat terminal is exposed to the outside of the case, and the second projected portion is formed with at least one opening through which a portion of the negative flat terminal is exposed to the outside of the case.

16. A secondary battery comprising:
a case having first and second flat end portions;
a generator unit installed in the case, the generator unit including a plurality of positive and negative electrode plates which are alternatively put on one another placing therebetween separator plates;
positive and negative flat terminals respectively held by the first and second end portions of the case, each of the flat terminals including an inside part exposed to an interior of the case and connected to corresponding ones of the positive and negative electrode plates, a middle part actually held by corresponding one of the first and second flat end portions of the case and an outside part exposed to the outside of the case;
a first sealing layer of melted plastic film through which the middle part of the positive flat terminal is held by the first flat end portion of the case; and
a second sealing layer of melted plastic film through which the middle part of the negative flat terminal is held by the second flat end portion of the case,
wherein each of the first and second sealing layers has an outside edge that projects by a given degree from a leading edge of corresponding one of the first and second flat end portions of the case toward a leading end of the outside part of the corresponding one of the positive and negative flat terminals.
